(19) United States
(12) Patent Application Publication
(10) Pub. No.: US 2009/0204705 A1
(43) Pub. Date: Aug. 13, 2009

(54) On Demand File Virtualization for Server Configuration Management with Limited Interruption

(75) Inventors: Borislav Marinov, Aliso Viejo, CA (US); Thomas K. Wong, Pleasanton, CA (US); Ron S. Vogel, San Jose, CA (US)

Correspondence Address: Nixon Peabody LLP (F5 PATENTS);Gunnar G. Leinberg, 1100 Clinton Square, Rochester, NY, 14604, US

(73) Assignee: ATTUNE SYSTEMS, INC., Santa Clara, CA (US)

(21) Appl. No.: 12/268,609

(22) Filed: Nov. 11, 2008

Related U.S. Application Data
(60) Provisional application No. 60/987,194, filed on Nov. 12, 2007.

(51) Int. Cl. G06F 17/30; G06F 15/173

(52) U.S. Cl. 709/224; 707/10; 707/E17.032

(57) ABSTRACT

Inserting a file virtualization appliance into a storage network involves configuring a global namespace of a virtualization appliance to match a global namespace exported by a distributed filesystem (DFS) server and updating the distributed filesystem server to redirect client requests associated with the global namespace to the virtualization appliance. Removing the file virtualization appliance involves sending a global namespace from the virtualization appliance to the distributed filesystem server and configuring the virtualization appliance to not respond to any new client connection requests received by the virtualization appliance.

### CROSS-REFERENCE TO RELATED APPLICATIONS

This patent application claims priority from U.S. Provisional Patent Application No. 60/987,194 entitled ON DEMAND FILE VIRTUALIZATION FOR SERVER CONFIGURATION MANAGEMENT WITH LIMITED INTERRUPTION filed Nov. 12, 2007 (Attorney Docket No. 3193/123).

This patent application also may be related to one or more of the following patent applications:

U.S. Provisional Patent Application No. 60/923,765 entitled NETWORK FILE MANAGEMENT SYSTEMS, APPARATUS, AND METHODS filed on Apr. 16, 2007 (Attorney Docket No. 3193/114).

U.S. Provisional Patent Application No. 60/940,104 entitled REMOTE FILE VIRTUALIZATION filed on May 25, 2007 (Attorney Docket No. 3193/116).

U.S. Provisional Patent Application No. 60/987,161 entitled REMOTE FILE VIRTUALIZATION METADATA MIRRORING filed Nov. 12, 2007 (Attorney Docket No. 3193/117).

U.S. Provisional Patent Application No. 60/987,165 entitled REMOTE FILE VIRTUALIZATION DATA MIRRORING filed Nov. 12, 2007 (Attorney Docket No. 3193/118).

U.S. Provisional Patent Application No. 60/987,170 entitled REMOTE FILE VIRTUALIZATION WITH NO EDGE SERVERS filed Nov. 12, 2007 (Attorney Docket No. 3193/119).

U.S. Provisional Patent Application No. 60/987,174 entitled LOAD SHARING CLUSTER FILE SYSTEM filed Nov. 12, 2007 (Attorney Docket No. 3193/120).

U.S. Provisional Patent Application No. 60/987,206 entitled NON-DISRUPTIVE FILE MIGRATION filed Nov. 12, 2007 (Attorney Docket No. 3193/121).

U.S. Provisional Patent Application No. 60/987,197 entitled HOTSPOT MITIGATION IN LOAD SHARING CLUSTER FILE SYSTEMS filed Nov. 12, 2007 (Attorney Docket No. 3193/122).

U.S. Provisional Patent Application No. 60/987,181 entitled FILE DEDUPLICATION USING STORAGE TIERS filed Nov. 12, 2007 (Attorney Docket No. 3193/124).

U.S. patent application Ser. No. 12/104,197 entitled FILE AGGREGATION IN A SWITCHED FILE SYSTEM filed Apr. 16, 2008 (Attorney Docket No. 3193/129).

U.S. patent application Ser. No. 12/103,989 entitled FILE AGGREGATION IN A SWITCHED FILE SYSTEM filed Apr. 16, 2008 (Attorney Docket No. 3193/130).

U.S. patent application Ser. No. 12/126,129 entitled REMOTE FILE VIRTUALIZATION IN A SWITCHED FILE SYSTEM filed May 23, 2008 (Attorney Docket No. 3193/131).

All of the above-referenced patent applications are hereby incorporated herein by reference in their entireties.

### FIELD OF THE INVENTION

This invention relates generally to storage networks and, more specifically, to a method for inserting and removing an in-line storage virtualization device in a non-disruptive manner.

### BACKGROUND OF THE INVENTION

In a computer network, NAS (Network Attached Storage) file servers provide file services for clients connected in a computer network using networking protocols like CIFS or any other stateful protocol (e.g., NFS-v4). Many companies utilize various file Virtualization Appliances to provide better storage utilization and/or load balancing. Those devices usually sit in the data path (in-band) between the clients and the servers and present a unified view of the name spaces provided by the back-end server. From the client perspective, this device looks like a single storage server; for the back-end servers, the device looks like a super client that runs a multitude of users. Since the clients cannot see the back-end servers, the virtualization device is free to move, replicate, and even take offline any of the user's data, thus providing the user with a better user experience.

Earlier attempts at storage virtualization includes Microsoft Distributed File System (DFS) for presenting a single namespace, but these solutions are out-of band solutions where the client machine directly accesses the back-end servers but hides this from its users and applications. Out of band solutions have the benefit of being extremely fast, but unfortunately do not allow easy and seamless migration and or load balancing between different back-end servers.

In-line file virtualization is the next big thing in Storage but it does come with some drawbacks. It is difficult to almost impossible to insert the Virtualization Appliance in the data path without visibly interrupting user and/or application access to the back-end servers. Removing the Virtualization Appliance without disruption is as difficult as placing it in-line.

There are some situations, such as in an I/O intensive environment, where the latency introduced by the in-band file virtualization is deemed not acceptable. On the other hand, only in-band file virtualization offers non-disruptive reconfiguration of a namespace without shutting down all file servers that are affected by the changes during the namespace reconfiguration. Thus, if users are willing not to use the full-features provided by the in-band file virtualization, it is desirable to have a file virtualization solution that is out-of-band during normal operation and in-band only while the namespace is being reconfigured. Such a solution extends in-band file virtualization's benefit of non-disruptive namespace reconfiguration to all file servers.

### SUMMARY OF THE INVENTION

When file virtualization is about to be implemented, the administrator faces the challenge of inserting the virtualization appliance without or with very limited interruption to user's access to the backend servers. By combining the knowledge of the back-end servers load, the DFS ability to redirect user access to a newly designated target, and the ability to force a user disconnect, the administrator is able to eliminate the user interruption and only in a very few cases cause an interim disruption the access of the user to the back end servers when a Virtualization Appliance is inserted in the data path between the clients machine(s) and the backend servers.

In accordance with one aspect of the invention there is provided a method for inserting a file virtualization appliance for maintaining consistency of the namespace during namespace reconfiguration in a storage network having one or more storage servers and having a distributed file system (DFS) server that exports a global namespace consisting of file objects exported by the storage servers in the storage network, and wherein clients of the storage network always consult the DFS server for the identification of a storage server that exports an unknown file object before accessing, and wherein clients of the storage network may choose to access a known file object directly from its storage server without consulting the DFS server for its accuracy. The method involves configuring a global namespace of the virtualization appliance to match a global namespace exported by the distributed filesystem server; and updating the distributed filesystem server to redirect client requests associated with the global namespace to the virtualization appliance.

In various alternative embodiments, the method may further involve, after updating the distributed filesystem server, ensuring that no clients are directly accessing the file servers; and thereafter sending an administrative alert to indicate that insertion of the virtualization appliance is complete. Ensuring that no clients are directly accessing the file servers may involve identifying active client sessions running on the file servers; and ensuring that the active client sessions include only active client sessions associated with the virtualization appliance. The virtualization appliance may be associated with a plurality of IP addresses, and ensuring that the active client sessions include only active client sessions associated with the virtualization appliance may involve ensuring that the active client sessions include only active client sessions associated with any or all of the plurality of IP addresses. Ensuring that no clients are directly accessing the file servers may involve sending a session close command to a file server in order to terminate an active client session unrelated to the virtualization appliance. Ensuring that no clients are directly accessing the file servers may involve monitoring activity associated with active client sessions; and sending an administrative alert presenting an administrator with an option to close the active client sessions. Ensuring that no clients are directly accessing the file servers may involve sending an alert to a client associated with an active client session requesting that the client close the active client session. The method may further involve automatically reconfiguring a switch to create a VLAN for the virtualization appliance. The distributed filesystem server may be configured to follow the Distributed File System standard. Connecting a virtualization appliance to the storage network may include connecting a first switch to a second switch, wherein the first switch is connected to at least one file server; connecting the virtualization appliance to the first switch; connecting the virtualization appliance to the second switch; and for each file server connected the first switch, disconnecting the file server from the first switch and connecting the file server to the second switch.

In accordance with another aspect of the invention there is provided a method for removing a virtualization appliance logically positioned between client devices and file servers in a storage network having a distributed filesystem server. The method involves sending a global namespace from the virtualization appliance to the distributed filesystem server; and configuring the virtualization appliance to not respond to any new client connection requests received by the virtualization appliance.

In various alternative embodiments, the method may further involve disconnecting the virtualization appliance from the storage network after a predetermined final timeout period. The method may also involve for any client request associated with an active client session received by the virtualization appliance during a predetermined time window, closing the client session. The predetermined time window may be between the end of a first timeout period and the predetermined final timeout period. The distributed filesystem server may be configured to follow the Distributed File System standard.

### BRIEF DESCRIPTION OF THE DRAWINGS

The foregoing and advantages of the invention will be appreciated more fully from the following further description thereof with reference to the accompanying drawings wherein:

FIG. 1 is a schematic block diagram of a three server DFS system demonstrating file access from multiple clients;

FIG. 2 is a schematic block diagram of a virtualized three server system;

FIG. 3 depicts the process sequence of adding the Virtualization Appliance to the network;

FIG. 4 depicts the process sequence of removing direct access between the client machines and the back-end servers;

FIG. 5 depicts the process sequence of restoring direct access between the client machines and back-end servers;

FIG. 6 is a logic flow diagram for logically inserting a virtualization appliance between client devices and file servers in a storage network, in accordance with an exemplary embodiment of the present invention; and

FIG. 7 is a logic flow diagram for removing a virtualization appliance from a storage network, in accordance with an exemplary embodiment of the present invention.

Unless the context suggests otherwise, like reference numerals do not necessarily represent like elements.

### DETAILED DESCRIPTION OF SPECIFIC EMBODIMENTS

Definitions. As used in this description and related claims, the following terms shall have the meanings indicated, unless the context otherwise requires:

File Virtualization: File virtualization is a technology that separates the full name of a file from its physical storage location. File virtualization is usually implemented as a hardware appliance that is located in the data path (in-band) between clients and the file servers. For users, a file Virtualization Appliance appears as a file server that exports the namespace of a file system. From the file servers' perspective, the file Virtualization Appliance appears as just a beefed up client machine that hosts a multitude of users.

Virtualization Appliance. A “Virtualization Appliance” is a network device that performs File Virtualization. It can be in-band or out-of-band device.

DFS. Distributed File System (a.k.a. DFS) is an out-of-band solution for presenting a single hierarchical view for a set of back-end servers. When the user data is replicated among multiple servers, DFS allows the clients to access the closest server based on a server ranking system. On the other hand, DFS does not provide any data replication, so in this case some other (non-DFS) solution should be used to ensure the consistency of the user data between the different copies of user data.

Embodiments of the present invention relate generally to a method for allowing a file server, with limited interruption, to be in the data path of a file virtualization appliance when reconfiguring the namespace exported by the file server and to be out of the data path of a file virtualization appliance to avoid incurring the latency introduced by the file virtualization appliance during normal operations.

Embodiments enable file virtualization to allow on-demand addition and removal of file servers under control by the file virtualization. As a result, out-of-band file servers can enjoy the benefit of continuous availability even during namespace reconfiguration.

### Default DFS Operations

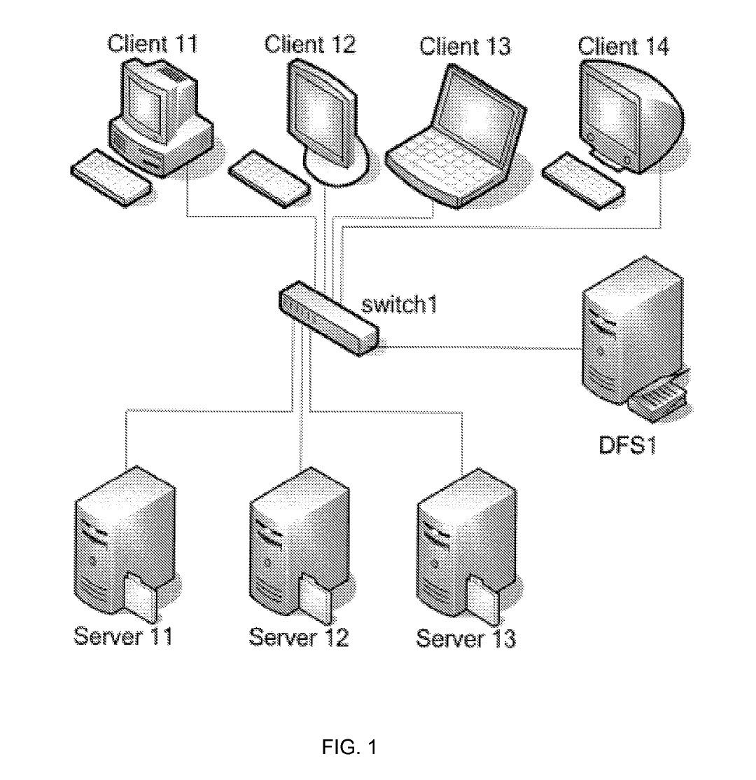

FIG. 1 demonstrates how the standard DFS based virtualization works. Client11 to Client14 are regular clients that are on the same network with the DFS server (DFS1) and the back-end servers (Server11 to Server13). The clients and the servers connect through a standard network file system protocol CIFS and/or NFS over a TCP/IP switch based network.

The Clients are accessing the global name space presented by the DFS1 server. When a client wants to access a file, the client sends its file system request to the DFS server (DFS1) which informs the client that the file is being served by another server. Upon this notification, the client forms a special DFS request asking for the file placement of the file in question. The DFS server instructs the client what portion of the file path is served by which server and where on that server this path is placed. The client stores this information in its local cache and resubmits the original request to the specified server. As long as there is an entry in its local cache, the client would never ask the DFS to resolve another reference for an entity residing within that path. The cache expiration timeout is specified by the DFS administrator and by default is set to 15 minutes. There is no way for the DFS server to revoke a cached reference or purge it from a client's cache.

Since the client implements the majority of the DFS functionality, there are some significant differences in how the cache timeout is implemented depending on the Operating System (OS) and the OS version. Some clients keep the entry in the cache for as long as there is any activity and/or an open handle on that path; other clients are a little bit stricter and do enforce the time out for any new opens that come after the timeout expires. This makes it extremely difficult to predict when the client will switch to the new references. To avoid any inconsistencies, the administrators force a reboot on the client's machines or log-in to those machines, install and run a special utility that flushes the whole DFS cache for all of the servers this client is accessing, which in turn forces the client to consult the DFS server the next time it tries to access that/any file from the global namespace.

### File Virtualization Operations

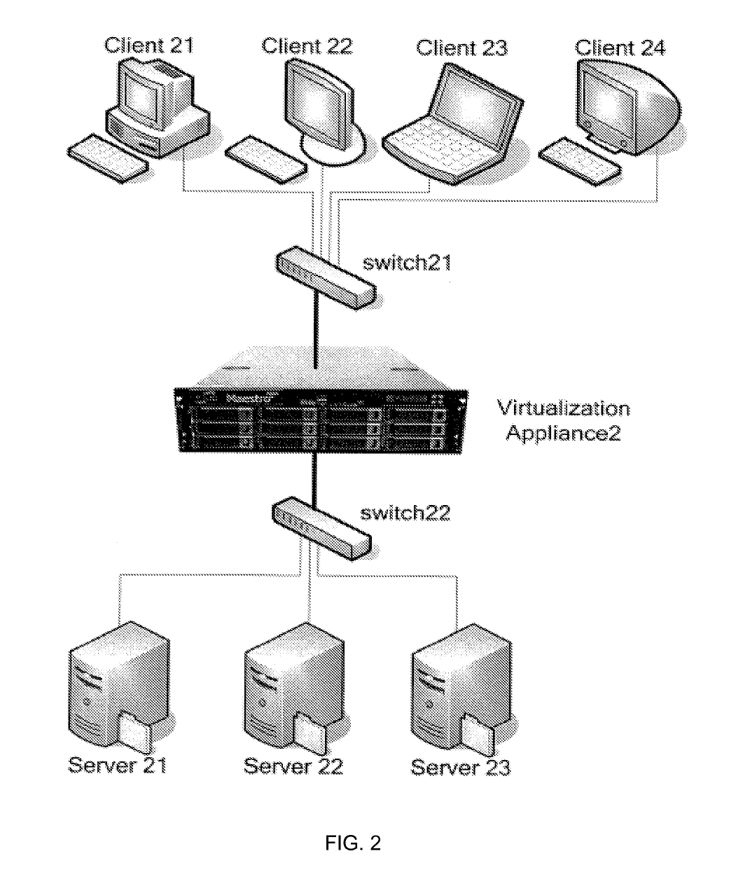

FIG. 2 illustrates the basic operations of a small virtualized system that consists of four clients (Client21 to Client24), three back-end servers (Server21 to Server23) a Virtualization Appliance, and couple of IP switches 21 and 22. When clients 21-24 try to access a file, the Virtualization Appliance 2 resolves the file/directory path to a server, a server share, and a path and dispatches the client request to the appropriate back-end server 21, 22 or 23. Since the client 21 does not have direct access to the back-end servers 21-23, the Virtualization Appliance 2 can store the files and the corresponding directories at any place and in whatever format it wants, as long as it preserves the user data. Some of the major functions include: moving user files and directories without user access interruptions, mirror the user files, load balancing, and storage utilization, among others.

### Physically Adding a Virtualization Appliance to a Storage Network.

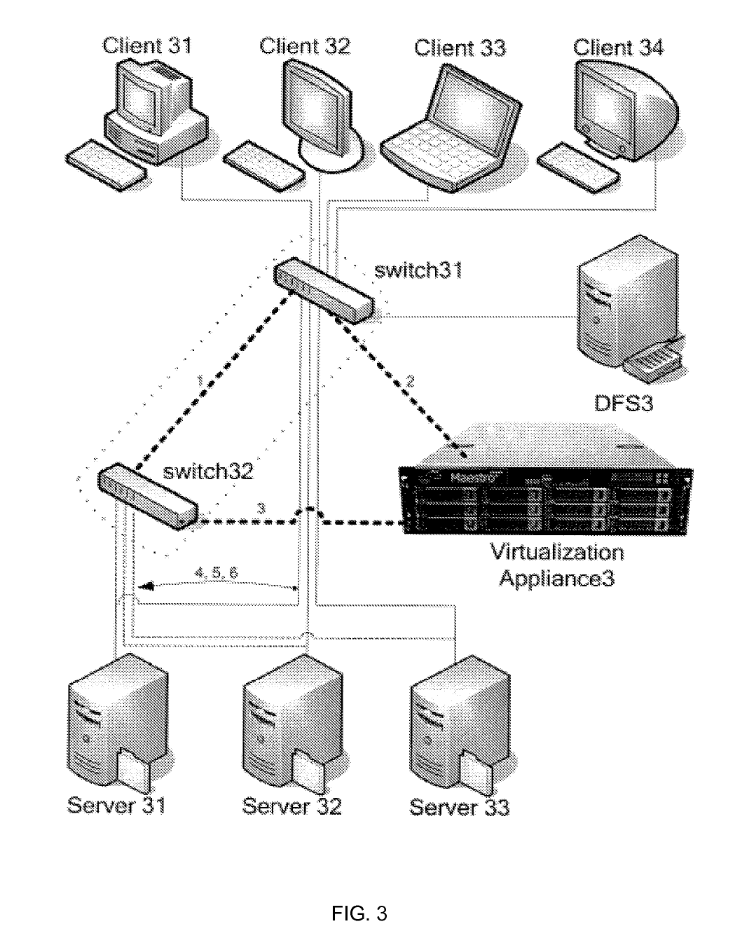

FIG. 3 demonstrates how the virtualization device is added to the physical network. The process includes manually bringing a virtualization device and an IP switch in a close proximity to the rest of the network and manually connecting them to the network.

First, administrator connects the second switch 32 to the current one 31 and connects the Virtualization Appliance 3 to both switches and turns them on (assuming they were not already on).

At this point, the administrator can unplug the first server 31 from the original switch 31 and connect it to the second switch 32. Since the network file system protocols go over a reliable transport protocol, there would be no interruption in the user/application activities as long as this operation completes within 2 to 5 seconds.

The same operation can be repeated with the rest of the servers. Alternatively, the administrator can do the hardware reconfiguration during scheduled server shut down and this way he doesn't have to worry how fast he can perform the hardware reconfiguration.

In case the IP switch is a managed switch with available ports for connection to the Virtualization Appliance 3, the above operations (aside from connecting the Virtualization Appliance to the switch) can be performed programmatically without any physical disconnect by simply reconfiguring the switch 31 to create two separate VLANs, one to represent switch 31 and one for switch 32.

### Inserting the Virtualization Appliance in the Data Path

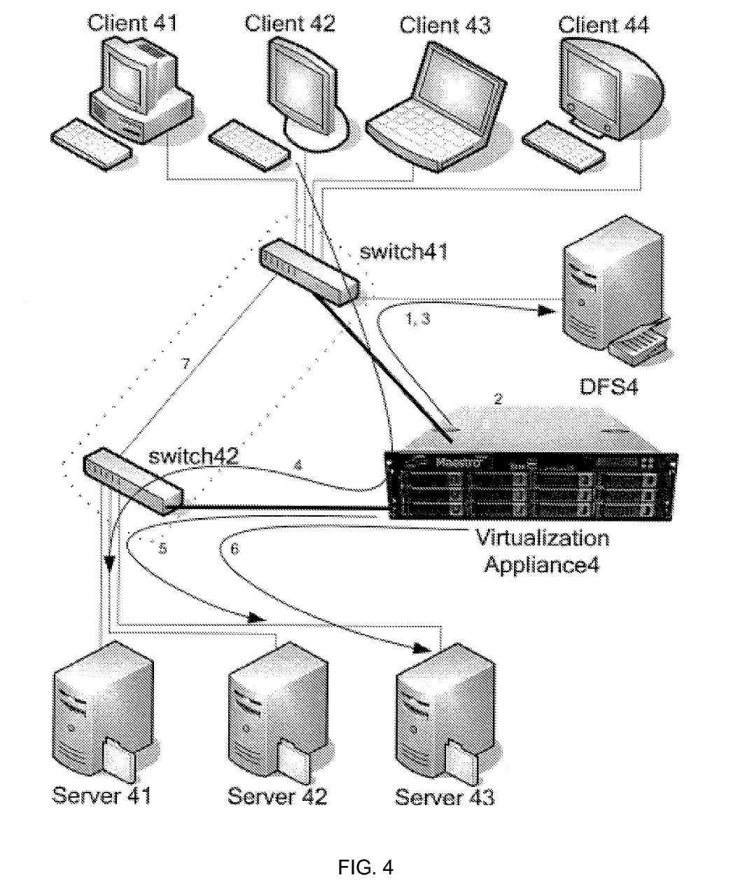

FIG. 4 describes the steps by which the Virtualization Appliance 4 is inserted in the data path with no interruption or minimal interruption to users.

The operation begins with the Virtualization Appliance 4 reading the DFS configuration from (DFS4, step1) configuring its global namespace to match the one exported by the DFS server 4 (step2) and updating the DFS server 4 configuration (step3) to redirect all of its global namespace to the Virtualization Appliance 4. This would guarantee that any opens after the clients cache expires would go through the Virtualization Appliance 4 (step 4).

There are several methods a Virtualization Appliance 4 can utilize to make sure that clients do not access the back-end servers. This is performed (in step5) by going to the back-end servers 41-43 and obtaining the list of user sessions established. There should be no other sessions except the sessions originated through one of the IP addresses of the Virtualization Appliance 4.

When all clients start accessing the back-end servers 41-43 through the Virtualization Appliance 4, the Virtualization Appliance 4 can send an administrative alert (e-mail, SMS, page) to indicate that the insertion has been completed, so the administrator can physically disconnect the two switches 41 and 42 (step 7). In the case of a managed switch, the Virtualization Appliance 4 can reconfigure the switch to separate the two VLANs.

In the case where there are user machines that do not want to retire a cached entry, the Virtualization Appliance can kick the user off of a predetermined server by sending a session close command (step6) to the server on which the user was logged on. This would force the user's machine to reestablish the session which triggers a refresh on the affected cache entries.

To limit the impact of the session close several methods can be implemented. If the user has no open files on that session, the session can be killed since the client does not have any state other than the session itself, which the client's machine can restore without any visible impact. If the user has been idle for a prolonged interval of time (e.g. 2 hours), this is an indication that the user session can be forcefully closed. If time is not a big issue, the Virtual Appliance 4 can perform a survey, monitoring the amount of open files and traffic load coming from the offending users and present the administrator with the option to trigger a session close when the user has the least amount of files and/or traffic. This way, the impact on the particular user would be minimized.

Another alternative is for the Virtualization Appliance 4 is to send an e-mail/SMG/page to the offending users, requesting them to reboot if twice the maximum specified timeout has expired.

With the administrator physically disconnecting the links between the two switches (switch41 and switch42), the virtual device insertion is completed.

Removing the Virtualization Appliance from the Data Path

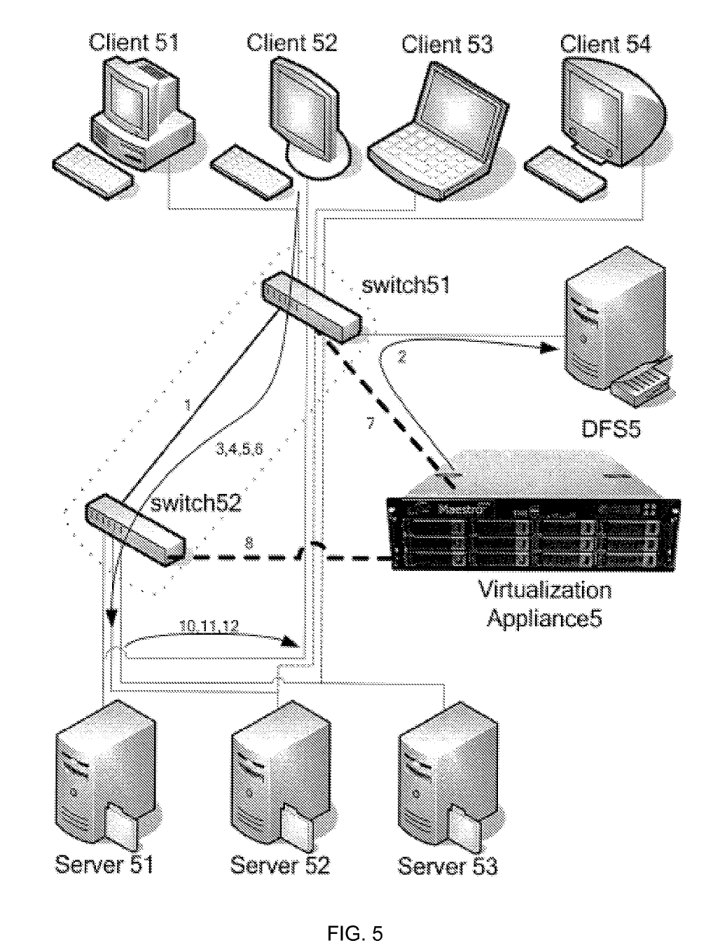

Removing the Virtualization Appliance (FIG. 5) is significantly easier than inserting it into the network.

The process begins with the administrator physically reconnecting the two switches (switch51 and switch52, step1). After that, the virtual device restores the initial DFS configuration (step2) and stops responding to any new connection establishments. In case some changes to the back-end file and directory placements are made, the Virtualization Appliance has to rebuild the DFS configuration based on the new changes.

After a while, all clients will log off from the Virtualization Appliance and connect directly to the back-end servers (steps3,4,5,6).

In case there are clients that do not go away after twice the original DFS timeout expires, the Virtualization Appliance can start kicking users off by applying the principles used when the appliance was inserted into the data path.

When there are no more user sessions going through, the administrator can safely power-down and disconnect the Virtualization Appliance from both switches (step7 and step8).

To restore the original topology, the administrator can move the back-end servers from switch52 to switch51 (steps10,11,12). And finally, the administrator can power down switch52 and disconnect it from switch51.

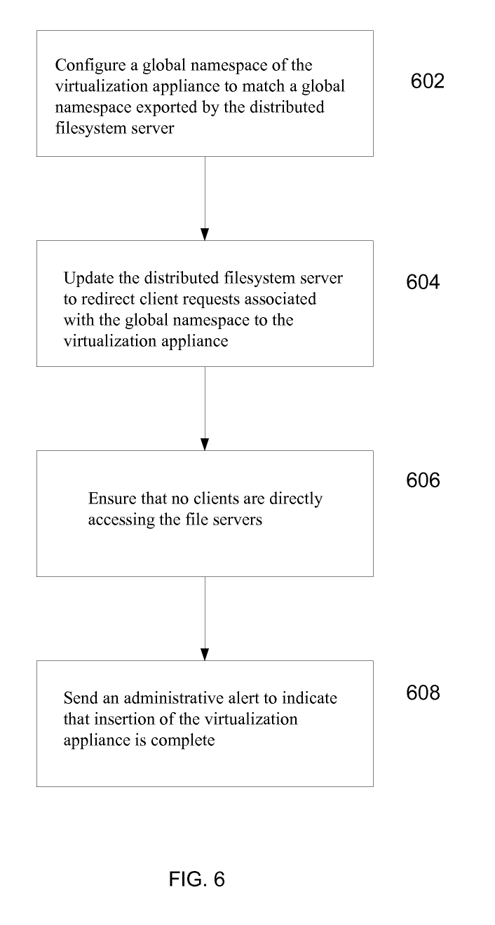

FIG. 6 is a logic flow diagram for logically inserting a virtualization appliance between client devices and file servers in a storage network, in accordance with an exemplary embodiment of the present invention. In block 602, a global namespace of the virtualization appliance is configured to match a global namespace exported by the distributed filesystem server. In block 604, the distributed filesystem server is updated to redirect client requests associated with the global namespace to the virtualization appliance. In block 606, the virtualization appliance ensures that no clients are directly accessing the file servers and in block 608 thereafter sends an administrative alert to indicate that insertion of the virtualization appliance is complete.

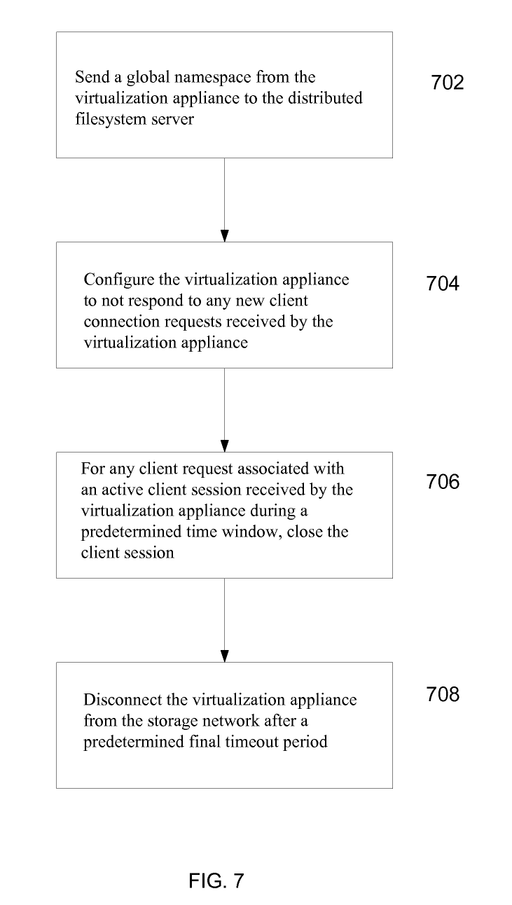

FIG. 7 is a logic flow diagram for removing a virtualization appliance from a storage network, in accordance with an exemplary embodiment of the present invention. In block 702, a global namespace is sent from the virtualization appliance to the distributed filesystem server. In block 704, the virtualization appliance is configured to not respond to any new client connection requests received by the virtualization appliance. In block 706, for any client request associated with an active client session received by the virtualization appliance during a predetermined time window, the virtualization appliance closes the client session. In block 708, the virtualization appliance is disconnected from the storage network after a predetermined final timeout period.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the described logic is implemented as a set of computer program instructions that is converted into a computer executable form, stored as such in a computer readable medium, and executed by a microprocessor under the control of an operating system.

It should be noted that embodiments of the subject patent application generally may be used in file switching systems of the types described in the provisional patent application referred to by Attorney Docket No. 3193/114. It should also be noted that embodiments of the present invention may incorporate, utilize, supplement, or be combined with various features described in one or more of the other referenced patent applications.

It should be noted that terms such as “client,” “server,” “switch,” and “node” may be used herein to describe devices that may be used in certain embodiments of the present invention and should not be construed to limit the present invention to any particular device type unless the context otherwise requires. Thus, a device may include, without limitation, a bridge, router, bridge-router (brouter), switch, node, server, computer, appliance, or other type of device. Such devices typically include one or more network interfaces for communicating over a communication network and a processor (e.g., a microprocessor with memory and other peripherals and/or application-specific hardware) configured accordingly to perform device functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. In a storage network having one or more storage servers and having a distributed file system (DFS) server that exports a global namespace consisting of file objects exported by the storage servers in the storage network, and wherein clients of the storage network always consult the DFS server for the identification of a storage server that exports an unknown file object before accessing, and wherein clients of the storage network may choose to access a known file object directly from its storage server without consulting the DFS server for its accuracy, a method of inserting a file virtualization appliance for maintaining consistency of the namespace during namespace reconfiguration, the method comprising:
configuring a global namespace of the virtualization appliance to match a global namespace exported by the distributed filesystem server; and
updating the distributed filesystem server to redirect client requests associated with the global namespace to the virtualization appliance.

2. A method according to claim 1, further comprising:
after updating the distributed filesystem server, ensuring that no clients are directly accessing the file servers; and
thereafter sending an administrative alert to indicate that insertion of the virtualization appliance is complete.

3. A method according to claim 2, wherein ensuring that no clients are directly accessing the file servers comprises:
identifying active client sessions running on the file servers; and
ensuring that the active client sessions include only active client sessions associated with the virtualization appliance.

4. A method according to claim 3, wherein the virtualization appliance is associated with a plurality of IP addresses, and wherein ensuring that the active client sessions include only active client sessions associated with the virtualization appliance comprises ensuring that the active client sessions include only active client sessions associated with any or all of the plurality of IP addresses.

5. A method according to claim 2, wherein ensuring that no clients are directly accessing the file servers comprises:
sending a session close command to a file server in order to terminate an active client session unrelated to the virtualization appliance.

6. A method according to claim 2, wherein ensuring that no clients are directly accessing the file servers comprises:
monitoring activity associated with active client sessions; and
sending an administrative alert presenting an administrator with an option to close the active client sessions.

7. A method according to claim 2, wherein ensuring that no clients are directly accessing the file servers comprises:
sending an alert to a client associated with an active client session requesting that the client close the active client session.

8. A method according to claim 2, further comprising:
automatically reconfiguring a switch to create a VLAN for the virtualization appliance.

9. A method according to claim 1, wherein the distributed filesystem server is configured to follow the Distributed File System standard.

10. A method according to claim 1, wherein connecting a virtualization appliance to the storage network includes:
connecting a first switch to a second switch, wherein the first switch is connected to at least one file server;
connecting the virtualization appliance to the first switch;
connecting the virtualization appliance to the second switch; and
for each file server connected the first switch, disconnecting the file server from the first switch and connecting the file server to the second switch.

11. A method for removing a virtualization appliance logically positioned between client devices and file servers in a storage network having a distributed filesystem server, the method comprising:
sending a global namespace from the virtualization appliance to the distributed filesystem server; and
configuring the virtualization appliance to not respond to any new client connection requests received by the virtualization appliance.

12. A method according to claim 11, further comprising:
disconnecting the virtualization appliance from the storage network after a predetermined final timeout period.

13. A method according to claim 11, further comprising:
for any client request associated with an active client session received by the virtualization appliance during a predetermined time window, closing the client session.

14. A method according to claim 13, wherein the predetermined time window is between the end of a first timeout period and the predetermined final timeout period.

15. A method according to claim 11, wherein the distributed filesystem server is configured to follow the Distributed File System standard.
